(19) United States
(12) Patent Application Publication
(10) Pub. No.: US 2005/0163559 A1
(43) Pub. Date: Jul. 28, 2005

(54) Jointer for connecting rod members

(76) Inventor: Jung-Shih Chang, Ta Li City (TW)

Correspondence Address: BROWDY AND NEIMARK, P.L.L.C.;624 NINTH STREET, NW, SUITE 300, WASHINGTON, DC, 20001-5303, US

(21) Appl. No.: 10/765,119

(22) Filed: Jan. 28, 2004

(51) Int. Cl. F16B 7/10

(52) U.S. Cl. 403/109.3

(57) ABSTRACT

A jointer for connecting two rod members includes a male connector for fastening to an end of one of the two rod members, and a female connector connectable to the male connector for fastening to an end of the other rod member. The female connector has a longitudinally extended receiving chamber having an opening, and a retaining element protruded into the receiving chamber. The male connector has a plug member, a guiding groove longitudinally extended on the plug member for accommodating the retaining element upon insertion of the plug member into the receiving chamber, and a transverse locating groove extended from a bottom end of the longitudinal guiding groove for receiving the retaining element upon rotation of the female connector relative to the male connector after insertion of the plug member into the receiving chamber of the female connector.

### BACKGROUND OF THE INVENTION

1. Field of the Invention

The present invention relates generally a jointer for connecting two rod members and, more particularly, to such a jointer, which enables two rod members to be rapidly connected with or detached from each other.

2. Description of the Related Art

In order to save storage space, a stick member, for example, the handle of a broom or sports gear, or a billiard cue is made detachable. For instance, a conventional billiard cue is generally comprised of a shaft and a butt connected to the shaft by a jointer. The jointer includes a screw rod axially fastened at a front end of the butt, and a nut embedded in a rear end of the shaft for threadedly fitting onto the screw rod. When in use, the screw rod is threaded into the nut to secure the butt to the shaft. When not in use, the screw rod is disengaged from the nut to separate the butt from the shaft for storage. This structure of jointer is functional; however, the user must rotate the shaft and the butt relative to each other through several turns when connecting the shaft and the butt, or separating these two members.

### SUMMARY OF THE INVENTION

It is the primary objective of the present invention to provide a jointer for connecting two rod members, which enables two rod members to be easily and rapidly connected with each other, and then conveniently detached from each other when desired.

To achieve this objective of the present invention, the jointer for connecting two rod members comprises a male connector for fastening to an end of one of the two rod members, and a female connector connectable to the male connector for fastening to an end of the other rod member. The female connector comprises therein a longitudinally extended receiving chamber having an opening, and a retaining element protruded into the receiving chamber. The male connector comprises a plug member having a free end and being insertable through the opening into the receiving chamber of the female connector, a guiding groove longitudinally inwardly extended from the free end of the plug member for accommodating the retaining element upon insertion of the plug member into the receiving chamber, and a transverse locating groove extended from a bottom end of the longitudinal guiding groove for receiving the retaining element upon rotation of the female connector relative to the male connector after insertion of the plug member into the receiving chamber of the female connector.

### BRIEF DESCRIPTION OF THE DRAWINGS

FIG. 1 is a plan view of a jointer according to a first preferred embodiment of the present invention, which shows that a female connecter and a male connecter are separated from each other.

FIG. 2 is a sectional view taken along line 2-2 of FIG. 1.

FIG. 3 is a sectional view taken along line 3-3 of FIG. 1.

FIG. 4 is a sectional view taken along line 4-4 of FIG. 1.

FIG. 5 is a schematic view showing the plug member of the male connector partially inserted into the female connector according to the first preferred embodiment of the present invention.

FIG. 6 is similar to FIG. 5 but showing the plug member of the male connector completely inserted into the receiving chamber of the female connector.

FIG. 7 is a sectional view taken along line 7-7 of FIG. 6.

FIG. 8 is a schematic sectional view of the first preferred embodiment of the present invention showing the female connecter and the male connecter are fixed in position together.

FIG. 9 is a sectional view taken along line 9-9 of FIG. 8.

FIG. 10 is similar to FIG. 2 but showing a cross sectional view of the female connector according to a second preferred embodiment of the present invention.

FIG. 11 is similar to FIG. 3 but showing a cross sectional view of the male connector according to the second preferred embodiment of the present invention.

FIG. 12 is a plan view of a jointer according to a third preferred embodiment of the present invention, which shows that a female connecter and a male connecter are separated from each other.

FIG. 13 is a sectional view taken along line 13-13 of FIG. 12.

FIG. 14 is a sectional view taken along line 14-14 of FIG. 12.

FIG. 15 is a schematic sectional view of the third preferred embodiment of the present invention showing the plug member of the male connector completely inserted into the receiving chamber of the female connector.

FIG. 16 is a schematic sectional view of the third preferred embodiment of the present invention showing the retaining elements respectively engaged into the transverse locating grooves of the male connector such that the female connecter and the male connecter are fixed in position together.

### DETAILED DESCRIPTION OF THE INVENTION

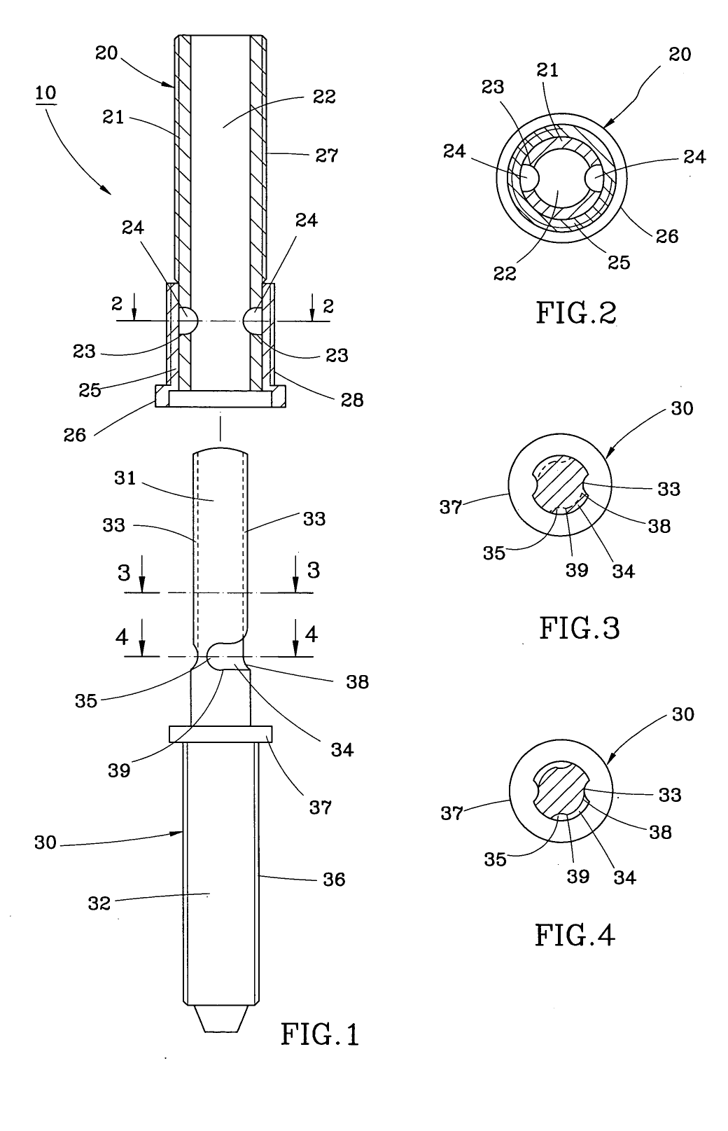

Referring to FIGS. 1˜4, a jointer 10 for connecting two rod members in accordance with the first preferred embodiment of the present invention is shown comprised of a female connector 20 and a male connector 30.

The female connector 20 comprises a cylindrical body 21, an end cap 25 capped on one end of the body 21, and two semispherical retaining elements 24. The body 21 has a longitudinal receiving chamber 22 axially extended through the two distal ends, two through holes 23 transversely extended through the peripheral wall at two sides near one end (the bottom end), and a thread 27 extended around the periphery of the upper part. The peripheral wall of each through hole 23 is a sphere. The longitudinal receiving chamber 22 has a circular cross section and an opening. The semispherical retaining elements 24 are respectively mounted in the through holes 23 of the body 21, each having the semispherical periphery disposed in contact with the periphery of the corresponding through hole 23 and partially projecting into the inside of the longitudinal receiving chamber 22. The end cap 25 is capped on the bottom end of the body 21 and covered over the through holes 23 to hold the semispherical retaining elements 24 in the through holes 23 of the body 21, having an annular receiving portion 26 at the bottom end around the opening of the receiving chamber, and a thread 28 extended around the outer periphery thereof.

The male connector 30 comprises a plug member 31 and a mounting member 32 axially connected in a line. The plug member 31 is a cylindrical rod having a diameter slightly smaller than that of the longitudinal receiving chamber 22 of the female connector 20, two longitudinal guiding grooves 33 of smoothly arched cross section (see FIG. 3) symmetrically disposed at two sides and respectively downwardly extended from the free (top) end to a predetermined distance, two transverse locating grooves 34 of smoothly arched cross section respectively, perpendicularly and integrally extended from the bottom ends of the longitudinal guiding grooves 33 in clockwise direction (see FIG. 4), and two retaining portions 35 respectively disposed at the ends of the transverse locating grooves 34 remote from the longitudinal guiding grooves 33. The transverse locating groove 34 has a width made gradually smaller from the start point 38 that is integrally connected to the respective bottom end of the longitudinal guiding groove 33 toward the end point 39 that is integrally connected to the retaining portions 35. The width of the end point 39 of each transverse locating groove 34 is slightly smaller than the width of the semispherical retaining elements 24. The retaining portions 35 are recessed holes having a width and depth relatively greater than the transverse locating grooves 34. The mounting member 32 extends axially downwardly from the bottom end of the plug member 31, having a top flange 37 extended around the top end and a thread 36 extended around the outer periphery thereof.

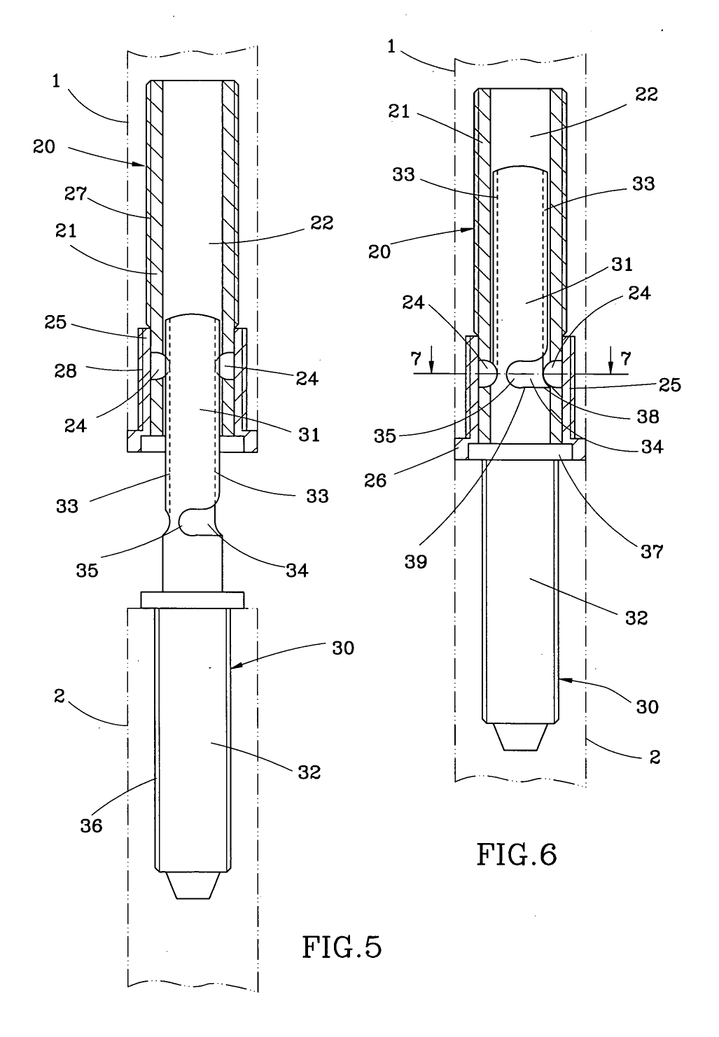

As shown in FIG. 5, the female connector 20 and the male connector 30 are respectively axially fastened to first and second rod members 1 and 2, e.g. the shaft and butt of a billiard cue. The female connector 20 is fastened to the first rod member 1 by means of the thread 27 of the body 21 and the thread 28 of the end cap 25, keeping the opening the longitudinal receiving chamber 22 exposed to the outside. The mounting member 32 of the male connecter 30 is fixedly inserted into the rod member 2 such that the plug member 31 is protruded from the rod member 2.

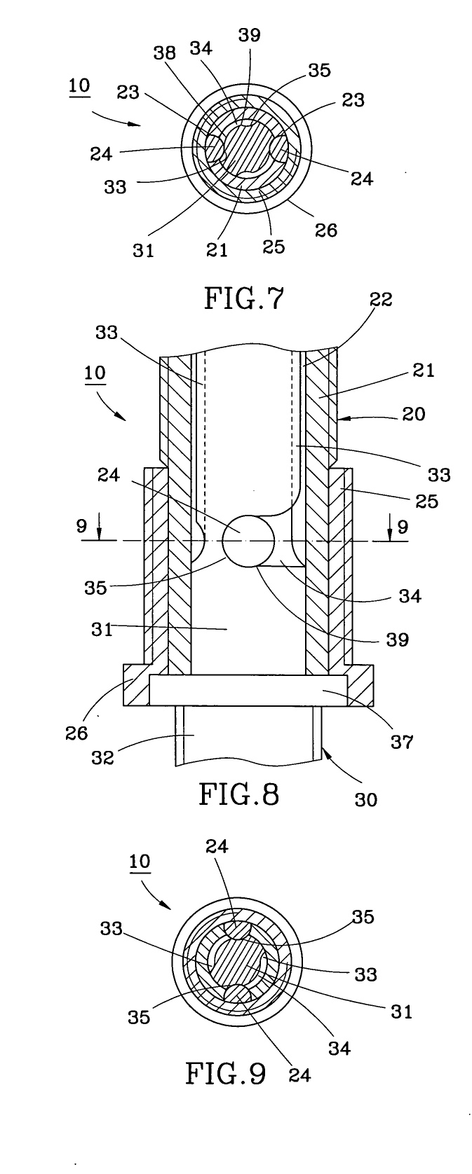

Referring to FIGS. 5-7, when fastening the first and second rod members 1 and 2, insert the plug member 31 of the male connector 30 through the opening of the longitudinal receiving chamber 22 into the inside of the longitudinal receiving chamber 22 to let the two semispherical retaining elements 24 be engaged into the two longitudinal guiding grooves 33 of the plug member 31 as shown in FIG. 5, and then push the plug member 31 forwards in the longitudinal receiving chamber 22 to the position where the start points 38 of the transverse locating grooves 34 are respectively aimed at the semispherical retaining elements 24 and the top flange 37 of the mounting member 32 is fitted into the annular receiving portion 26 of the end cap 25 as shown in FIGS. 8 and 9, and then rotate the second rod member 2 with the male connector 30 relative to the first rod member 1 with the female connector 20 to move the semispherical retaining elements 24 through the transverse locating grooves 34 over the end points 39 of the transverse locating grooves 34 into engagement with the retaining portions 35, and therefore the first and second rod members 1 and 2 are firmly connected in a line.

When separating the rod members 1 and 2, rotate the second rod member 2 relative to the first rod member 1 in the reversed direction to move the two semispherical retaining elements 24 away from the retaining portions 35 through the transverse locating grooves 34 into the longitudinal guiding grooves 33, and then axially pull the first rod member 1 and the second rod member 2 apart.

By means of the aforesaid arrangement, the invention enables two rod members to be quickly and detachably connected in a line.

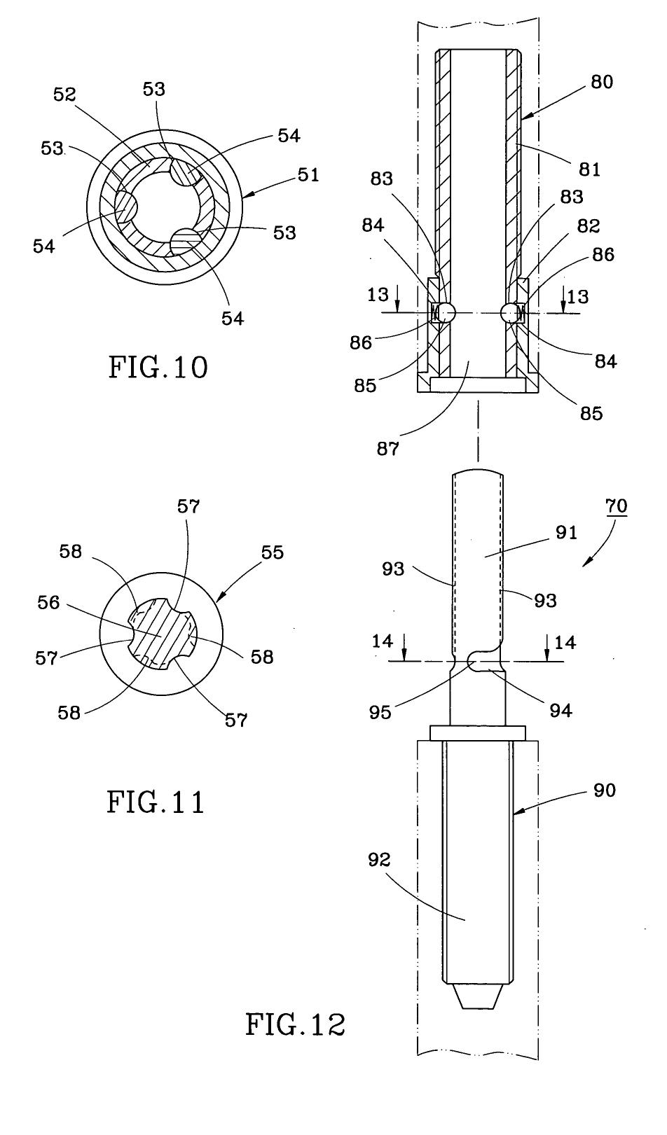

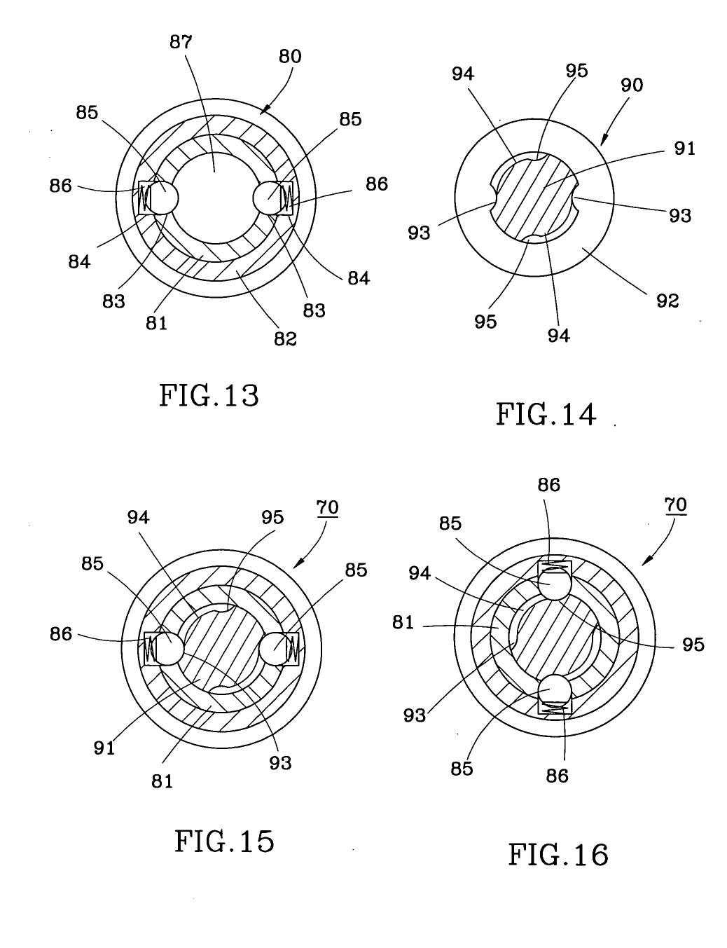

The semispherical retaining elements of the female connector are adapted to be engaged into the transverse locating grooves of the male connector. The number and structure of the semispherical retaining elements may be various embodied. FIGS. 10 and 11 show a jointer according to the second preferred embodiment of the present invention. This embodiment is substantially similar to the aforesaid first preferred embodiment with the exception that the body 52 of the female connector 51 has three through holes 53 equiangularly spaced around the periphery and respectively mounted with a respective semispherical retaining elements 54, and the plug member 56 of the male connector 55 has three longitudinal guiding grooves 57 equiangularly spaced around the periphery thereof and three transverse locating grooves 58 respectively extended from the bottom ends of the longitudinal guiding grooves 57. When rotating the female connector 51 relative to the male connector 55 after insertion of the male connector 55 into the female connector 51, the semispherical retaining elements 54 are respectively engaged into the transverse locating grooves 58, and therefore the male connector 55 and the female connector 51 are firmly connected in a line.

FIGS. 12˜14 show a jointer 70 for connecting two rod members according to the third preferred embodiment of the present invention. According to this embodiment, the jointer 70 is comprised of a female connector 80 and a male connector 90. The female connector 80 comprises a connector body 81 and an end cap 82 capped on one end of the connector body 81. The connector body 81 has two transverse through holes 83 symmetrically disposed at two opposite sides. The peripheral wall of each transverse through hole 83 is a sphere. The male connector 90 comprises a plug member 91 and a mounting member 92. The plug member 91 comprises two longitudinal guiding grooves 93 symmetrically disposed at two sides and respectively downwardly extended from the free (top) end to a predetermined distance, two transverse locating grooves 94 respectively, perpendicularly and integrally extended from the bottom ends of the longitudinal guiding grooves 93 in clockwise direction and terminating in a respective retaining portion 95.

Unlike the aforesaid first preferred embodiment, each transverse locating groove 94 has the same width from the start point to the end point. Further, the end cap 82 has two recessed inside holes 84 formed in the inside wall at two opposite sides corresponding to the transverse through holes 83. Two compression springs 86 are respectively mounted in the recessed inside holes 84. Two retaining balls 84 are respectively mounted in the transverse through holes 83 and supported on the compression springs 86. The compression springs 86 force the retaining balls 85 toward the inside of the longitudinal receiving chamber 87 of the connector body 81. However, the peripheral wall of each transverse through hole 83 prohibits the respective retaining ball 85 from falling to the inside of the longitudinal receiving chamber 87. As shown in FIGS. 15 and 16, when inserted the plug member 91 of the male connector 90 into the longitudinal receiving chamber 87 of the female connector 80, the retaining balls 85 are respectively supported in the longitudinal guiding grooves 93 of the plug member 91 and slightly forced backwards (radially outwards) by the peripheral wall of each longitudinal guiding groove 93 to compress the respective compression spring 86. When rotating the female connector 80 relative to the male connector 90 at this time, the retaining balls 85 will be moved from the longitudinal guiding grooves 93 into the transverse locating grooves 94 and then engaged into the retaining portions 95. By means of the spring power of the compression springs 86, the retaining balls 85 are firmly maintained in engagement with the retaining portions 95 to hold the female connector 80 and the male connector 90 in the connected condition firmly.

1. A jointer for connecting two rod members, said jointer comprising:
a male connector for fastening to an end of one of the two rod members;
a female connector connectable to said male connector for fastening to an end of the other rod member;
wherein said female connector includes a longitudinally extended receiving chamber having an opening, and a retaining element protruded into said receiving chamber;
wherein said male connector includes a plug member having a free end and being insertable through said opening into said receiving chamber of said female connector, a guiding groove longitudinally extended from said free end of the plug member for accommodating said retaining element upon insertion of said plug member into said receiving chamber, and a transverse locating groove extended from a bottom end of said longitudinal guiding groove for receiving said retaining element upon rotation of said female connector relative to said male connector after insertion of said plug member into said receiving chamber of said female connector;
wherein said transverse locating groove has a start point integrally connected to the bottom end of said longitudinal guiding groove, and an end point;
wherein said transverse locating groove has a width made gradually smaller from the start point toward the end point thereof, and the end point of said transverse locating groove has a width smaller lightly than that of said retaining element.

2. The jointer as claimed in claim 1, wherein said female connector comprises a cylindrical connector body defining said receiving chamber therein and having a transverse through hole, which has a spherical peripheral wall, in which said retaining element is mounted such that said retaining element peripherally partially protrudes into said receiving chamber, and an end cap capped on an end of said connector body and covered over said transverse through hole to hold down said retaining element in said transverse through hole.

3. The jointer as claimed in claim 1, wherein said transverse locating groove further comprises a recessed retaining portion integrally connected to the end point thereof for receiving said retaining element, said recessed retaining portion having a depth and width relatively greater than the other part of said transverse locating groove.

4. The jointer as claimed in claim 1, wherein said retaining element has a sphere partially projecting into said receiving chamber of said female connector.

5. The jointer as claimed in claim 1, wherein said female connector comprises an annular receiving portion disposed in a bottom end thereof around the opening of said receiving chamber; said male connector comprises a mounting member axially extended from said plug member and having a flange connectable to said annular receiving portion of said female connector upon insertion of said plug member into said receiving chamber of said female connector.

6. The jointer as claimed in claim 1, wherein said female connector comprises a thread extended around an outer periphery thereof for fastening to said one of the two rod members; said male connector comprises a mounting member axially extended from said plug member and having a thread extended around an outer periphery thereof for fastening to said end of the other rod member.

7. The jointer as claimed in claim 1, wherein said female connecter comprises two said retaining elements symmetrically disposed in said receiving chamber of said female connector at tow sides; said male connecter comprises two said longitudinal guiding grooves symmetrically formed on said plug member of said male connector at two sides.

8. The jointer as claimed in claim 1, wherein said female connecter comprises three said retaining elements equiangularly spaced in said receiving chamber of said female connector; said male connecter comprises three said longitudinal guiding grooves equiangularly formed on said plug member of said male connector.

9. A jointer for connecting two rod members, said jointer comprising:
a male connector for fastening to an end of one of the two rod members;
a female connector connectable to said male connector for fastening to an end of the other rod member;
wherein said female connector includes a longitudinally extended receiving chamber having an opening, and a traverse through hole, which is communicated with said receiving chamber, in which a retaining element and a spring member are received, said retaining element being supported on said spring member and partially protruded into said receiving chamber;
wherein said male connector includes a plug member having a free end and being insertable through said opening into said receiving chamber of said female connector, a guiding groove longitudinally extended from said free end of the plug member for accommodating said retaining element upon insertion of said plug member into said receiving chamber, and a transverse locating groove extended from a bottom end of said longitudinal guiding groove for receiving said retaining element upon rotation of said female connector relative to said male connector after insertion of said plug member into said receiving chamber of said female connector;
wherein said transverse locating groove has a start point integrally connected to the bottom end of said longitudinal guiding groove, and an end point that has a depth deeper than the other part of said transverse locating groove.

10. The jointer as claimed in claim 9, wherein said spring member is a compression spring.
